(19) United States
(12) Patent Application Publication
(10) Pub. No.: US 2018/0256442 A1
(43) Pub. Date: Sep. 13, 2018

(54) VIBRATORY MASSAGE ROLLER DEVICE

(71) Applicant: Trent Lee, Las Vegas, NV (US)

(72) Inventor: Trent Lee, Las Vegas, NV (US)

(21) Appl. No.: 15/926,233

(22) Filed: Mar. 20, 2018

(51) Int. Cl. A61H 15/00; A61H 23/02

(52) U.S. Cl. CPC A61H 15/0078; A61H 2201/1215; A61H 2015/0014; A61H 23/0254

(57) ABSTRACT

A massage roller that includes a motor coupled to a power source configured to rotate at a plurality of speeds within an enclosure defined by a hollow casing. The massage roller further includes a rotatable member attached to a motor driveshaft that rotates when the motor driveshaft transmits power from the motor to the rotatable member, to cause a plurality of vibrations within a hollow space enclosed by the hollow casing. An amplitude of the plurality of vibrations may be based on a speed of the motor. The massage roller further includes an outer layer formed of a compressible material covering an external surface of the hollow casing. The outer layer may include at least one pattern of ridges extending radially from the external surface, may receiving the plurality of vibrations from the hollow space and reverberate mechanical vibrations to a subject in contact with the massage roller.

### BACKGROUND

### Technical Field

The present disclosure relates generally to the field electro-medical massage devices. More, particularly, the present disclosure relates to electrical massage rollers.

### Description of the Related Art

Massaging muscles, ligaments, tendons and other soft tissues before a workout helps address muscle tightness, muscle knots, and blood circulation to muscles and connective tissues thereby preventing injury due to lack of flexibility. Accordingly, massaging muscles and ligaments using massaging devices post-workout helps loosening up muscles and removing lactic acid thereby aiding in reduction of pain and faster recovery of sore muscles. To facilitate aforementioned massages, massage rollers have been integrated as an essential tool in physical training, muscle workout and rehabilitation practices.

Traditional massage rollers typically include a hollow tubular structure made of solid foam material. For example, a typical massage roller is rolled manually against a body part of a user such as a back, thigh, calves, arms, shoulders and the like to stretch and massage the respective body part. Alternatively the user may balance on the massage roller in a reclining position such as on the back, a side or on the stomach, to enable a weight of the body to apply pressure to the muscles that are directly on top of the roller. Aforesaid techniques tend to be manually tedious and may require expertise on behalf of the user while balancing on the massage roller.

Further, such traditional massage rollers have known to cause compression of soft tissues under application of excessive manual force. Furthermore, certain sore muscles may need to be isolated and massaged at a different intensity than surrounding muscles and connective tissues. The traditional massage rollers fail to provide varying intensities of massage without manual effort.

Hence there is a need for an improved massage roller that can provide varying intensities of massage to isolated groups of muscles. Further, the improved massage roller should provide effective massage therapy to the user without use of manual effort. Therefore, an improved massage roller for providing varying intensities of massage is proposed.

The above-mentioned shortcomings, disadvantages, and problems are addressed herein and which will be understood by reading and studying the following specification.

### OBJECTIVES OF THE EMBODIMENTS HEREIN

A primary object of the present disclosure is to provide a vibratory massage roller that provides varying intensities of massage based on varying vibratory speeds of an in-built motor.

Another object of the present disclosure is to provide a massage roller that provides an effective massage automatically and thereby excluding need for human expertise and manual effort.

Yet another object of the present disclosure is to provide a portable lightweight massage roller having a small profile that is convenient to maneuver and carry along.

Yet another object of the present disclosure is to provide durable and sturdy massage roller that can be used on a continuous basis with optimum performance.

These and other objects and advantages of the embodiments herein will become readily apparent from the following detailed description taken in conjunction with the accompanying drawings.

### SUMMARY

The embodiments herein disclose a massage roller that provides massaging effect to a body of a subject is disclosed. According to an embodiment herein, the massage roller includes a motor coupled to a power source configured to rotate at a plurality of speeds within an enclosure defined by a hollow casing. Further the massage roller includes a rotatable member attached to a motor driveshaft that rotates when the motor driveshaft transmits power from the motor to the rotatable member, to cause a plurality of vibrations within a hollow space enclosed by the hollow casing. An amplitude of the plurality of vibrations is based on a speed of the motor. The motor driveshaft is mechanically coupled to the motor. Further, the massage roller includes an outer layer formed of a compressible material covering an external surface of the hollow casing. The outer layer includes at least one pattern of ridges extending radially from the external surface. Further, the outer layer is capable of receiving the plurality of vibrations from the hollow space and reverberating mechanical vibrations to a subject in contact with the massage roller.

According to one embodiment herein, a process of facilitating massage of a subject is disclosed. The process includes providing a massage device to the subject, where the massage device includes a motor coupled to a power source configured to rotate at a plurality of speeds within an enclosure defined by a hollow casing. Further the massage device includes a rotatable member attached to a motor driveshaft that rotates when the motor driveshaft transmits power from the motor to the rotatable member, to cause a plurality of vibrations within a hollow space enclosed by the hollow casing. An amplitude of the plurality of vibrations is based on a speed of the motor. The motor driveshaft is mechanically coupled to the motor. Further, the massage device includes an outer layer formed of a compressible material covering an external surface of the hollow casing. The outer layer includes at least one pattern of ridges extending radially from the external surface. Further, the outer layer is capable of receiving the plurality of vibrations from the hollow space and reverberating mechanical vibrations to a subject in contact with the massage roller. The process further includes, contacting the massage device to the subject to transmit the mechanical vibrations to the subject.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will be apparent to those skilled in the art from the following description of the preferred embodiment herein and the accompanying drawings in which:

FIG. 1A-1B illustrate perspective views of a massage roller, according to one embodiment herein.

FIG. 2A illustrates a sectional view depicting components of the massage roller, in accordance with an embodiment herein.

FIG. 2B illustrates a plan view of a motor of the massage roller, in accordance with an embodiment herein.

FIG. 3 illustrates an elevation view of the massage roller, in accordance with an embodiment herein.

FIG. 4 illustrates a plan view of the massage roller, in accordance with an embodiment herein.

FIG. 5A illustrates an elevation view of the massage roller, depicting at least one pattern of ridges, in accordance with an embodiment herein.

FIG. 5B illustrates a sectional view of the massage roller depicting a sectional view of the at least one pattern of ridges, in accordance with an embodiment herein.

FIG. 6 illustrates an elevation view of the massage roller, in accordance with an embodiment herein.

FIG. 7 illustrates an elevation view of the massage roller, in accordance with an embodiment herein.

FIG. 8A-8B illustrates the massage roller for providing massaging effect to back and leg of a subject, in accordance with an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

Several massage devices and tools have been included as a part of muscle workout and rehabilitation practices, for physical conditioning and facilitating muscle relaxation in a subject. A massage roller is one such massage device that has proven to be indispensible during pre and post workout procedures. Prior to a workout, a massage roller is typically rolled over one or more body parts of the subject to loosen out and stretch muscles effectively, in order to avoid strain on stiff muscles during the workout. Various materials used on the external surface of the massage roller and pressure applied on the massage roller help in providing deep tissue massages. Post workout, use of the massage roller facilitates relaxation of muscles and general well-being of the subject. However different muscle groups may require varying intensities of massage, thereby requiring the massage roller to exert varying forces depending on the muscle groups. By varying physical forces applied on the roller, the massage roller may exert varying forces when rolled over the muscle groups. However, varying physical forces on the roller typically require manual effort on behalf of the subject or on behalf of another person such as a physical trainer.

The present disclosure includes a vibratory massage roller that can provide varying intensities of massage based on vibrations produced by a rotating member housed within the massage roller. The rotating member is typically a heavy weight solid object that is rotated by a motor coupled to a power source. During rotation of the rotating member, vibrations are caused within the massage roller. The vibrations are transferred to an outer layer of the massage roller that is typically made of foam material. Upon receiving the vibrations, the outer layer exhibits mechanical vibrations which are further transferred to a subject that comes in contact with the outer layer of the roller. By changing the speed of the rotating member, the vibrations produced within the massage roller may be varied. As a result, varying vibrations are transferred to the outer layer and hence the subject. The speed of the rotating member can be change by changing a speed of the motor.

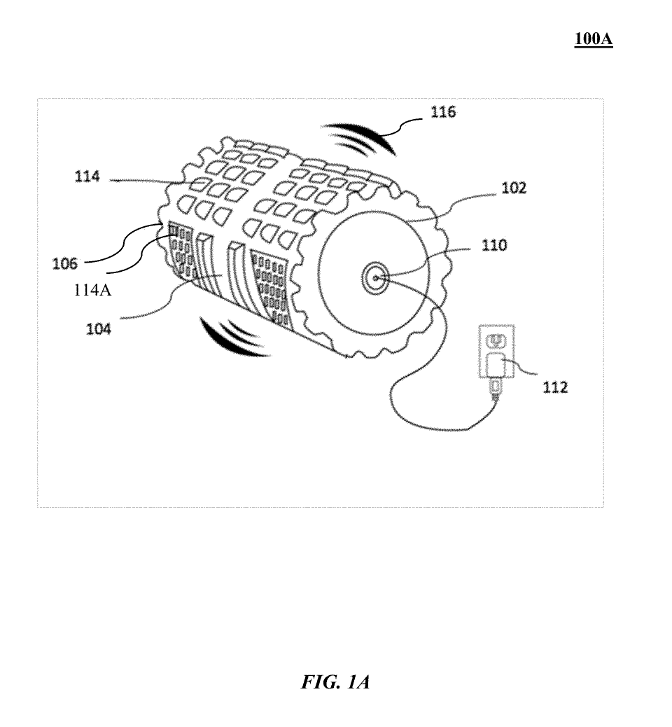

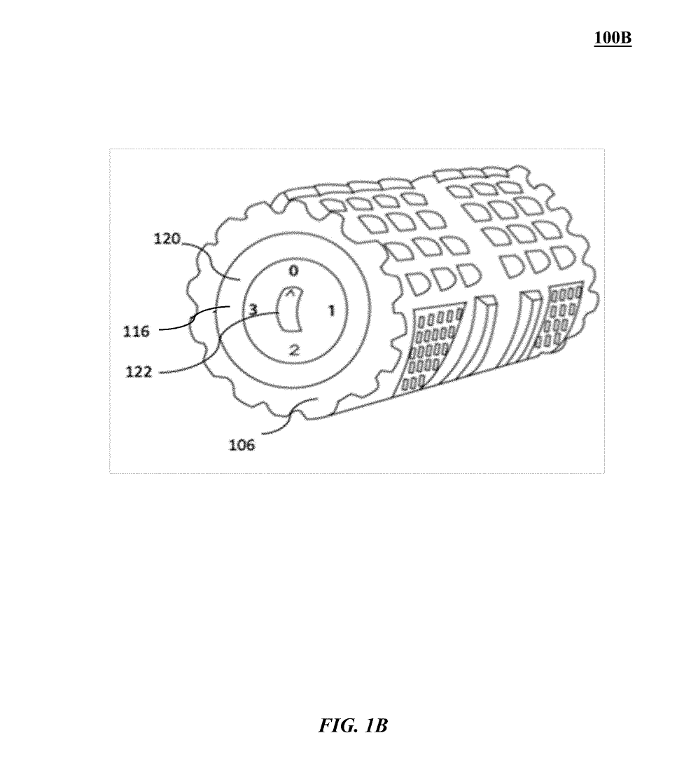

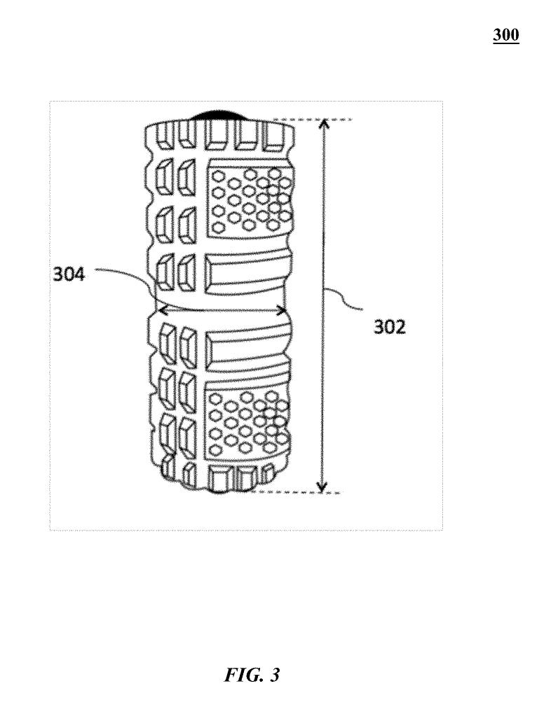

FIG. 1A, illustrates a perspective view of a massage roller 100 in accordance with an example. The massage roller 100 includes a hollow casing 102, a first truncated end 108, a second truncated end 106, an outer layer 104, an external surface 118, at least one pattern of ridges 114, and a charge slot 110. The massage roller 100 is depicted to be connected to a power adaptor 112. The hollow casing 102, is depicted herein as a right cylinder, however it may be appreciated that other cross-sectional shapes such as oval, triangular, square, pentagonal, hexagonal and higher polygonal shapes may be incorporated. The hollow casing 102 may be made of a plurality of hard materials such as poly vinyl chloride (PVC), polyacrylates, polyacrylics, polycarbonates, polyamides, polyurethane, acetal co-polymers, aluminum, steel and combinations thereof, to enhance a sturdiness and weight bearing capability of the massage roller 100. In an example embodiment, the hollow casing 102 may have a diameter of 3.5 inches to 6 inches. Further, the hollow casing 102 may have a length of 10 inches to 15 inches. As shown in an elevation view in FIG. 3, the diameter 304 of the massage roller is 5.5 inches, and the length 302 is 13 inches, in accordance with an example.

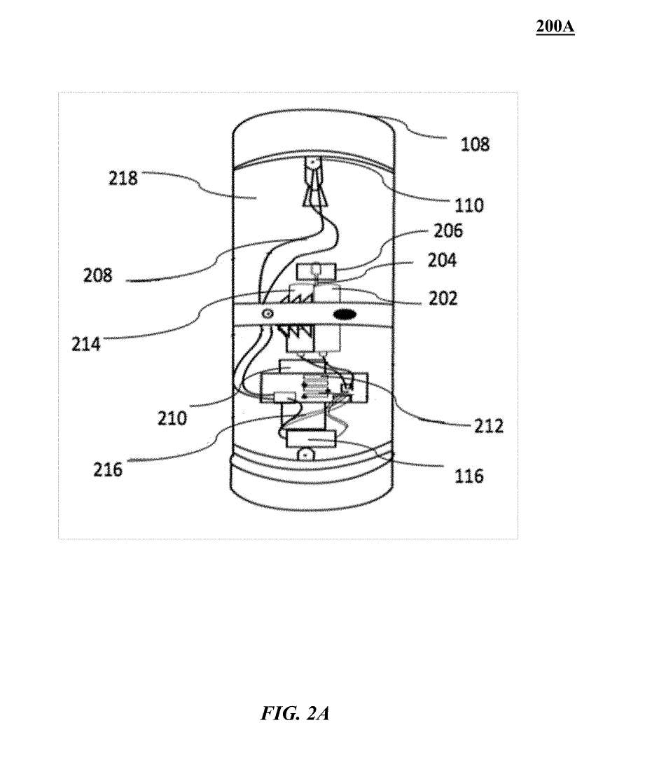

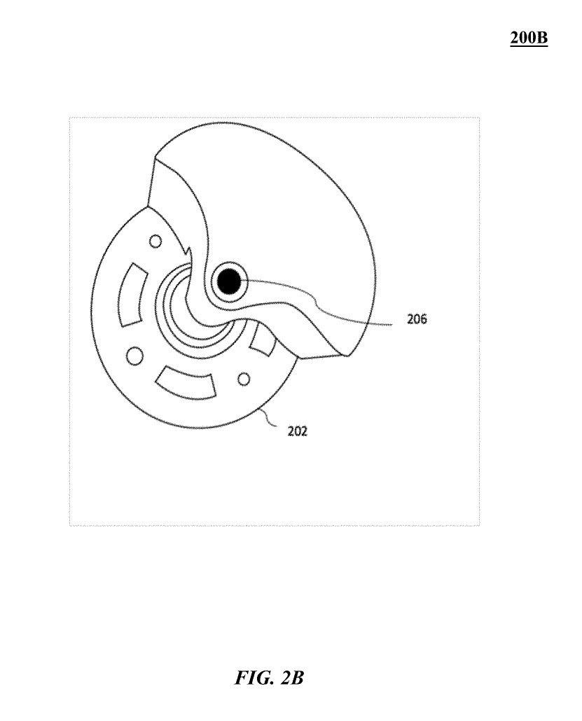

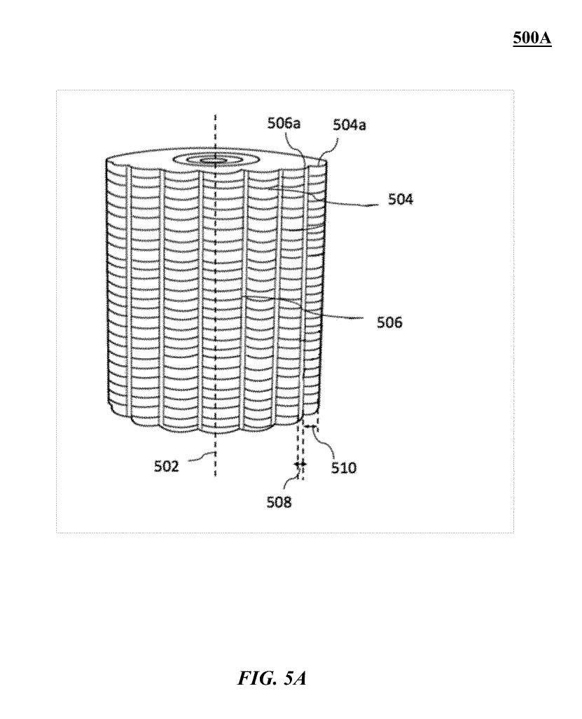

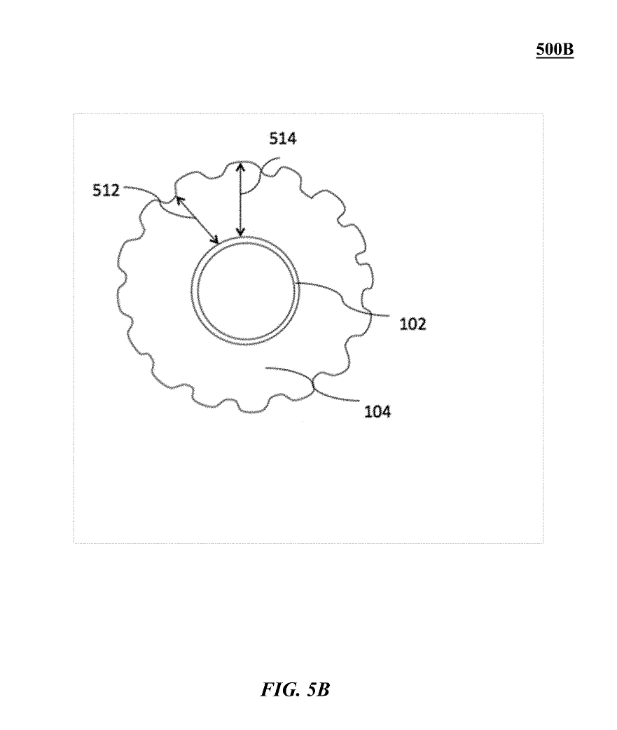

Further, the outer layer 104 may be overlaid onto the external surface 118 of the massage roller 100. In an example embodiment, the outer layer 104 may be using fasteners, snap fittings or may be pressure fit. Hence, the outer layer 104 may be a replaceable or permanent. The outer layer 104 may include a compressible material such as vinyl rubber, natural rubber, foam, cotton or any other deformable material that can present a pleasing surface to the subject. The compressible material provides impact resistance and skid resistance, thereby relieving the subject from skid related accidents. Further the compressible material is such that the outer layer 104 can efficiently reverberate vibrations caused within the hollow casing 102 as mechanical vibrations 116 to a subject in contact with the external surface 118. Further, the outer layer 104 incudes at least one pattern of ridges 114 that facilitate deep tissue massage. Various embodiments of the at least one pattern of ridges 114 is envisaged in the present disclosure to facilitate a plurality of massaging effects to the subject in contact with the external surface 118. The various embodiments illustrating the at least one pattern of ridges 114 is explained with reference to FIGS. 5A-5B, FIG. 6 and FIG. 7. It may be understood that use of firmer materials for the outer casing 104 may provide deeper tissue massage as compared to softer materials. The thickness of the outer layer may be of 0.5 inches to 2.5 inches depending on the diameter 304 of the massage roller 100, and an amplitude and frequency of the vibrations caused within the hollow casing 102. The amplitude and the frequency of vibrations caused within the hollow casing 102 can be altered by a selector switch 116 as shown in FIG. 1B. The selector switch 116 includes a rotation button 122, and is mounted within a switch mounting socket 120. The vibrations caused within the hollow casing 102 is explained in reference to FIG. 2A-2B.

FIG. 2A illustrates a cross-sectional view of the massage roller 100 depicting components that cause the vibrations within the hollow casing 102. The massage roller 100 includes as motor 202, a motor driveshaft 204, a rotatable member 206, a power source 210, one or more resistive elements 212, first set of electrical connector(s) 208, a second set of electrical connector(s) 216, a third set of electrical connector(s) 218, a motor frame 214 and a plurality of detents 216. The motor 202 is coupled to the power source 210 by the third set of electrical connector(s) 218. In an example, the power source 210 includes one or more rechargeable batteries capable providing electrical power to the motor 202 to enable rotation of the motor 202 at a plurality of speeds. The power source 210 can be recharged by power supply provided via the first set of electrical connector(s) 208. The first set of electrical connector(s) 208 is connected to the charge slot 110 configured to receive a power outlet of the power adaptor 112, that provides the power supply. The power adaptor 112 can a typical dc adaptor capable of being plugged into an alternating current (AC) power mains supply unit and converting AC power into Direct current (DC) power.

Further, the motor 202 is mechanically coupled to one end of the motor driveshaft 204, and the other end of the motor driveshaft 204 is attached to the rotatable member 206. The motor driveshaft 204 is typically a cylindrically shaped solid object and is capable of transmitting power from the motor 202 to the rotatable member 206. The rotatable member 206 is a sectoral-shaped heavy weight solid object capable of rotating at the plurality of speeds and of causing a plurality of vibrations comprising of a plurality of amplitudes and frequencies within a hollow space enclosed within the hollow casing 102, when the motor 202 rotates at the plurality of speeds. A plan view of the motor 202 depicted in FIG. 2B illustrates the sectoral-shape of the rotatable member 206 in an example embodiment. In an example, the rotatable member 206 may weigh 0.25 kilograms to 0.75 kilograms. It may be understood that the weight of the rotatable member 206 decides the amplitude of the plurality of vibrations caused. For example, a heavier weighted rotatable member may cause vibrations of larger amplitudes in comparison to a light weighted rotatable member. For example, when the motor 202 rotates at a predefined speed upon receiving a power corresponding to the predefined speed from the power source 210, the motor driveshaft 204 also rotates which in turn rotates the rotatable member 206 to cause a plurality of vibrations within the hollow space enclosed within the hollow casing 102 having an amplitude corresponding to the predefined speed.

The motor 202 is configured to rotate at the predefined speed from the plurality of speeds when the power source 210 energizes the motor 202 at the predefined speed by providing power corresponding to the predefined speed. Further, the power source 210 energizes the motor 202 by the corresponding power based on a vibration speed selected using the selector switch 116. Upon selecting the vibration speed, a resistive element, selected from the one or more resistive elements 212, corresponding to the vibration speed is connected between the power source 210 and the motor 202 by the selector switch 116, to control power provided to the motor 202.

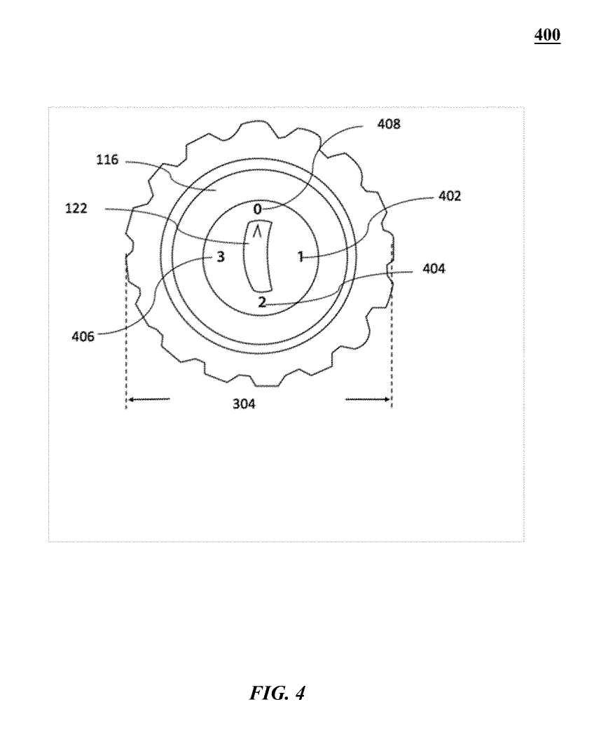

In an example, the selector switch 116 is operable to selectively vary the one or more resistive elements 212 connected between the power source 210 and the motor 202 based on the vibration speed selected by using the rotation button 122 of the selector switch 116, which in effect changes the speed of the motor 202. The selector switch 116 is connected to the one or more resistive elements 212 via the second set of electrical connector(s) 216. For example, FIG. 4 illustrates a plurality of vibration speeds that may be selected using the rotation button 122. As shown, the rotation button 122 can be operated between at least four positions, where at a first position 402, the power source 210 energizes the motor 202 at a first vibrating speed, at a second position 404 the power source 210 energizes the motor 202 at a second vibrating speed, at a third position 406 the power source 210 energizes the motor 202 at a third vibrating speed, and at a fourth position the power source 210 de-energizes and shuts off the motor 202. As a result, the motor 202 may be energized to three vibrations speeds. In another example, the at least four positions may be illustrated as off, low, medium and high, where low, medium and high illustrate the three vibration speeds. In another example, the vibration speed selected by the rotation button 122 may be displayed on a LCD screen or any other visual display. In another example, the rotation button 122 may be operated between five positions, thereby resulting in energizing the motor 202 to four vibrations speeds. In another example, the rotation button 122 may be operated between six positions, thereby resulting in energizing the motor 202 to five different vibrations speeds.

During operation, when the motor 202 rotates at the plurality of speeds, and due to the plurality of vibrations caused within the hollow space, a positional alignment of the motor 202 may be disturbed. Hence, the motor frame 214 is provided to support and secure the motor 202 in an intended position within the hollow casing 102. In an example, the motor frame 214 may be a cylindrical hollow structure with a circular cross-section and open ends circumscribing the motor 202 and may have an exterior surface including a plurality of detents 216 extending radially from the exterior surface and spaced at a uniform distance along a circumference of the exterior surface. Each detent may be attached to an inner surface of the hollow casing 102 for providing the support. Further, the each detent is designed to have a large surface area in order to dissipate heat generated during operation of the motor 202. The plurality of detents 216 may be in form of grooves, ribs or similar structures that secure the motor frame 214 to the hollow casing 102. Alternatively the plurality of detents 216 may be provided within the hollow casing 102 to support the motor frame 214. Further, the plurality of detents 216 may increase efficiency of transmission of the plurality of vibrations.

Further, the outer layer 104 is capable of receiving the plurality of vibrations from the hollow space and reverberating mechanical vibrations 116 (as shown in FIG. 1A) to the subject in contact with the external surface 118. In an example embodiment, the mechanical vibrations 116 may be exhibited along a length of the massage roller 100. Further, the mechanical vibrations 116 as experienced by the subject depend on the at least one pattern of ridges 114 extending radially from the external surface 118. A plurality of embodiments of the massage roller 100 having different pattern of ridges on the external surface 118 is depicted in FIG. 5-7.

FIG. 5A, illustrates an elevation view of a massage roller 500 depicting at least one pattern of ridges, in accordance with an embodiment. It may be understood that the components as depicted in FIG. 2A of the massage roller 100 are incorporated within the massage roller 500. The at least one pattern of ridges 114 as depicted on massage roller 100 in FIG. 1A, undergo a variation in the massage roller 500 embodiment. The at least one pattern of ridges of the massage roller 500 include a plurality of grooves extending axially and along a longitudinal axis 502 of the massage roller 100 on the outer layer 104 and formed of the compressible material. A cross sectional width 510 of a ridge 504a may be twice as large as a cross-sectional width 508 of a groove 506a. Further, as shown in FIG. 5B, a cross-sectional height 514 of the ridge 504a may be twice as large as a cross-sectional height of the groove 506a.

For example, the cross-sectional width 510 of the ridge 504a may be 0.02 inches and the cross-sectional width 508 of the groove 506a maybe 0.01 inches. Further, the cross-sectional height 514 of the ridge 504a may be 0.01 inches and the cross-sectional height 512 of the groove 506a maybe 0.005 inches.

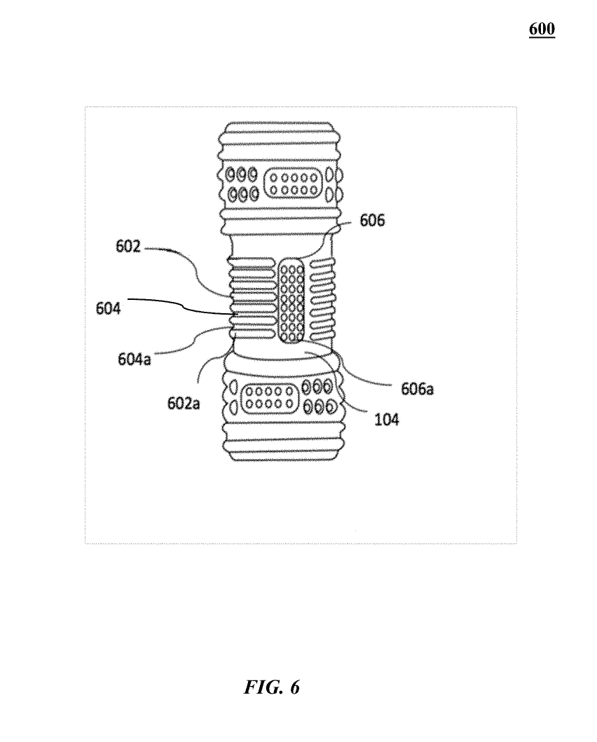

FIG. 6, illustrates an elevation view of a massage roller 600 depicting at least one pattern of ridges, in accordance with another embodiment. It is understood that the components as depicted in FIG. 2A of the massage roller 100 are incorporated within the massage roller 600. The at least one pattern of ridges 114 as depicted on massage roller 100 in FIG. 1A, undergo a variation in the massage roller 600 embodiment. The at least one pattern of ridges of the massage roller 600 include a plurality of ridges 602 and a plurality of grooves 604 extending axially and along a circumference of the massage roller 100 on the outer layer 104. The at least one pattern of ridges 114 may be formed of the compressible material. Further, a ridge 602a may have a cross-sectional height at least twice as large as a cross-sectional height of a groove 604a. Further, the ridge 602a may have a cross-sectional width at least twice as large as a cross-sectional width of the groove 604. Furthermore, the at least one pattern of ridges 114 may be interspersed with at least one patch of polygonal shaped lobes 606, where each lobe 606a is spaced at a uniform distance from another lobe 606b in the at least one patch 606. Furthermore, the each lobe 606a may have a cross sectional height at least less than half the cross-sectional height of the ridge 602a. For example, the cross-sectional width of the ridge 602a may be 0.02 inches and the cross-sectional width of the groove 604a maybe 0.01 inches. Further, the cross-sectional height of the ridge 602a may be 0.01 inches and the cross-sectional height of the groove 604a maybe 0.005 inches. Further, in the example, the cross-sectional height of the each lobe 606a may be less than 0.0067 inches and greater than 0.005 inches.

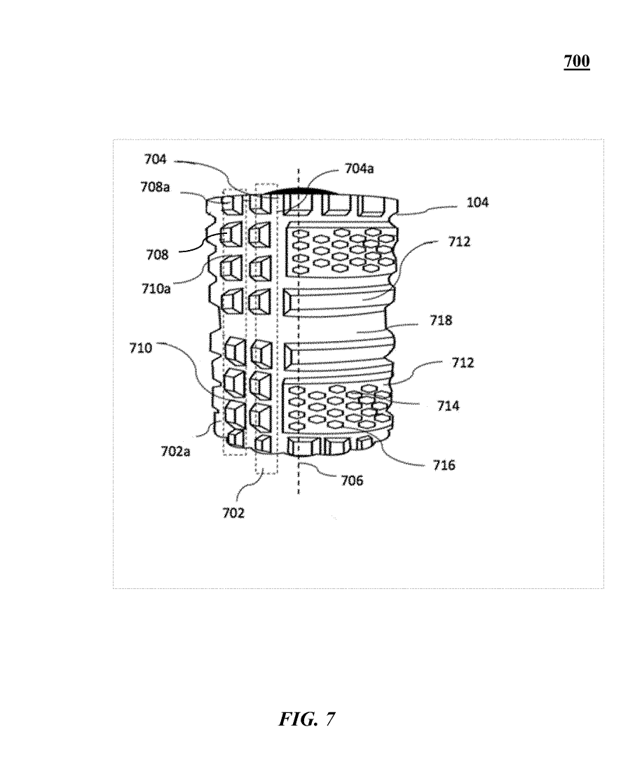

FIG. 7 illustrates an elevation view of the massage roller 100 depicting the at least one pattern of ridges 114, in accordance with another embodiment. The at least one pattern of ridges 114, comprises a plurality of ridges 702 and a plurality of first grooves 704 extending axially and along a longitudinal axis 706 of the massage roller 100 on the outer layer 104 and formed of the compressible material. Further, a ridge 702a further comprising of a continuous pattern of alternating plurality of lobes 708 and a plurality of second grooves 710 extending axially on the outer layer 104 and along a part of longitudinal axis 706. Further, a lobe 708a may have a cross-sectional height at least twice as large as a cross-sectional height of a second groove 710a. Further, the lobe 708a may have a cross sectional width equal to a cross-sectional width of the second groove 710a. Further, the ridge 702a may have a cross-sectional width at least twice as large as a cross-sectional width of a first groove 704a. Furthermore, the at least one pattern of ridges 114 may be interspersed by a patch 718 comprising the outer layer 104 extending along a circumference of the hollow casing 102 and positioned at the center of the longitudinal axis 706.

The patch 718 may have a cross-sectional width equal to the cross-sectional width of the lobe 708a. Furthermore, the at least one pattern of ridges 114 includes a plurality of fused lobes 712 having a length equal to a summation of lengths of two or more lobes, and a width equal to a summation of widths of the two or more lobes. One or more fused lobes of the plurality of fused lobes 712, may include a plurality of polygonal shaped smaller lobes 714, spaced uniformly on a front surface 716 of the one or more fused lobes. Further, a cross-sectional height of a fused lobe may be equal to the cross-sectional height of the each lobe such as the lobe 708a.

The at least one pattern of ridges 114 as shown and described above, illustrate some representative embodiments. Different patterns of ridges may be incorporated in addition to the disclosed at least one pattern of ridges 114 in FIG. 5-7. For example, the at least one pattern of ridges 114 may include a discontinuous pattern of ridges, grooves and lobes. The spacing of the ridges, grooves and lobes may be such as to present a substantially smooth exterior surface 118 when applied to a body of the subject.

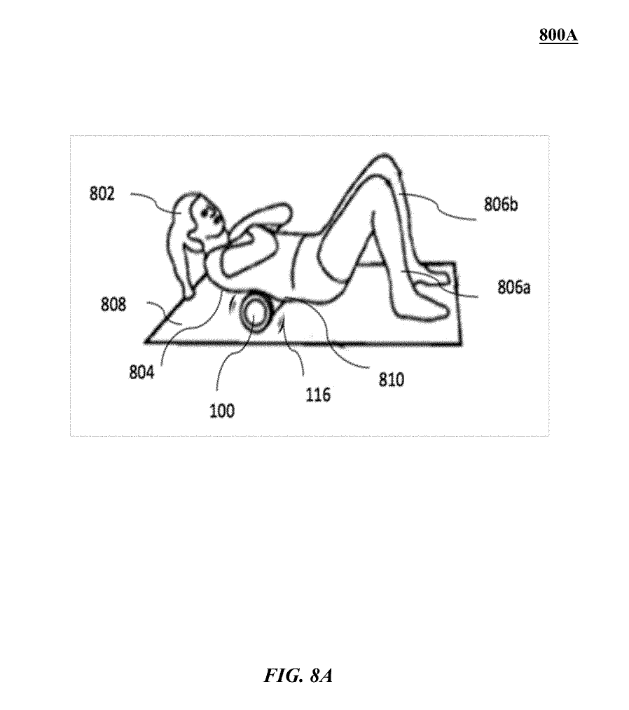

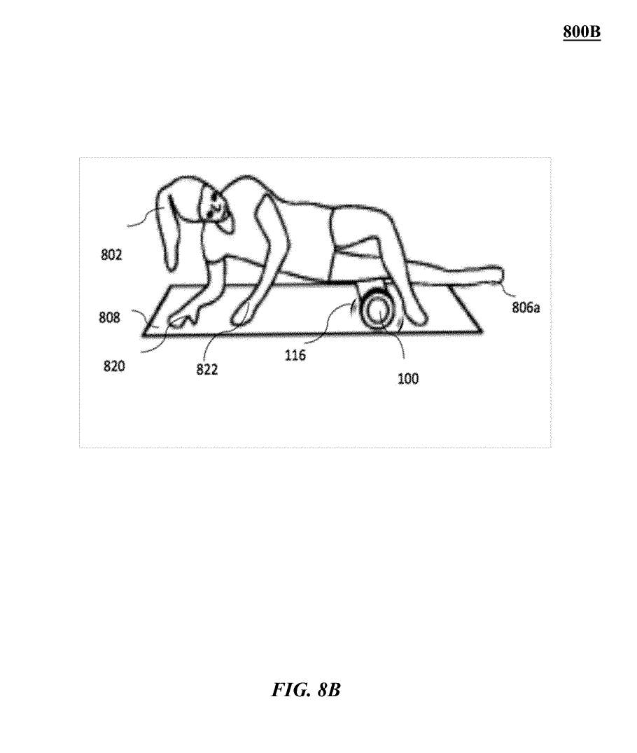

Aforementioned embodiments of the massage roller 100 enable effecting massage on the subject by contacting the massage roller 100 in an energized state with the subject. The massage roller 100 exhibits the mechanical vibrations 116 along a length of the massage roller 100, which are transferred to at least one body part of the subject upon said contact. Exemplary uses of the massage roller 100 can be explained with reference to FIG. 8A- 8B.

FIG. 8A illustrates, an environment 800 in which exemplary uses of the massage roller 100 may be effected on a body of a subject 802. The environment 800 may be a home, gym, a physiotherapist's clinic, a workout studio or an outdoor place. The environment 800 includes the subject 802 lying on a surface 808. The surface 808 may be a floor, a workout table, a mattress, a cot and the like. The subject 802 may turn the rotation button 122 to a particular vibrating speed, for example a high vibrating speed, in order to energize the motor 202. Upon being energized, the mechanical vibrations 116 caused by the motor 202 are exhibited on the external surface 118 of the massage roller 100.

Further, in order to massage a lower back 810 of the subject 802, the massage roller 100 may be positioned below the lower back 810. The subject 802 may position the lower back 810 such that the at least one pattern of ridges 114 of the massage roller 100 is placed against a muscle or tissue of the lower back 810 that needs to be massaged. During operation, the mechanical vibrations 116 exert direct pressure on the muscle or the tissue, and surrounding connective tissues that are brought in contact with the massage roller 100, resulting in greater flexibility and body wellness.

Further, using right leg 806a and left leg 806b, the subject 802 may exert mechanical force on the massage roller 100, in a direction that rolls the massage roller 100 on the surface 808 towards a different muscle or tissue of the lower back 810 or of an upper back 804 that needs to be massaged. As a result, upon aforesaid rolling, the massage roller 100 may be positioned at the different muscle or tissue of the lower back 810 that needs relaxation. For relaxation of other body parts such as hips, thighs, calves, arms, hands, spine, abdomen, chest, neck and shoulders of the subject 802, the massage roller 100 needs to be brought into contact with respective body parts. Accordingly another exemplary use of the massage roller 100 is illustrated in FIG. 8B.

FIG. 8B illustrates the environment 800, where the subject 802 is using the massage roller 100 to relax a thigh muscle of the leg 806a. The subject 802 is propped up on a right elbow 820 and takes support of his left hand 822 to position a thigh of the leg 806a on the at least one pattern of ridges 114 of the massage roller 100. The subject 802 may roll the thigh back and forth on the surface 808 to facilitate transmission of the mechanical vibrations 116 to various muscle groups and tissues of the thigh of the right leg 806a. Similarly by getting into a plurality of body positions the subject 802 may emphasize one or more body parts on the massage roller 100 to achieve an overall massage, flexibility and wellness in the body.

Although preferred embodiments have been illustrated, it is understood that variations in construction within the scope of the disclosure may be implemented. For example, the massage roller 100 may be of a plurality of sizes and shapes, apart from depicted cylindrical shape. Additionally, grips or handles may be provided on the ends of the massage roller 100, to enable a user such as the subject 802 to control amount of force applied on the massage roller 100 when the massage roller 100 is used in a manual mode.

The technical advantages envisaged by the present disclosure include provisioning of multiple speeds of vibration of the massage roller 100, for facilitating varying intensities of massage to the subject without manual intervention. Prior to work out or rehabilitation exercises, disclosed massage roller 10 enables deep tissue massage of muscles, ligaments and connective tissues that loosen up and relax the muscles, thereby preventing injuries that usually occur while exercising stiff muscles. Accordingly, the massage roller 100 can effectively reduce lactic acid buildup in muscles that get sore post workout, thereby reducing pain and facilitating quick recovery. Further, the present disclosure envisages, multiple designs of the at least one pattern of ridges 114 formed on the outer layer 104 to enable a plurality of massage effects depending on a requirement of the subject. The requirement of the subject may include deep tissue massage, supple gentle massage, or superficial massage. The massage roller 100 is also skid-resistant due to the at least one pattern of ridges 114 provided on the external surface 104, thereby reducing a tendency of the user to slip on the massage roller. Further, the massage roller is soft to touch and yet durable due to a polyvinyl chloride (PVC) construction of the hollow casing. Furthermore, requirement for the massage roller 100 is utmost essential for sportspersons especially athletes that fly often to sports destinations. Accordingly, the present disclosure envisages a lightweight compact sized massage roller 100 that can fit easily into a travel case and comes handy during travel.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A massage roller comprising:
a motor coupled to a power source configured to rotate at a plurality of speeds within an enclosure defined by a hollow casing;
a rotatable member attached to a motor driveshaft that rotates when the motor driveshaft transmits power from the motor to the rotatable member, to cause a plurality of vibrations within a hollow space enclosed by the hollow casing, an amplitude of the plurality of vibrations based on a speed of the motor, the motor driveshaft mechanically coupled to the motor; and
an outer layer formed of a compressible material covering an external surface of the hollow casing, the outer layer comprising at least one pattern of ridges, the outer layer capable of receiving the plurality of vibrations from the hollow space and reverberating mechanical vibrations to a subject in contact with the massage roller.

2. The massage roller of claim 1, wherein the rotatable member is a sectoral-shaped heavy weight solid object capable of rotating at a plurality of speeds based on the speed of the motor and causing the plurality of vibrations comprising of a plurality of amplitudes and frequencies.

3. The massage roller of claim 1, further comprising a charge slot provided at a first truncated end of the hollow casing configured to receive a power outlet of a power adaptor that provides power supply to recharge the power source.

4. The massage roller of claim 1, wherein the power source comprises of one or more rechargeable batteries.

5. The massage roller of claim 1, further comprising a selector switch operable to selectively vary one or more resistive elements connected between the power source and the motor based on a vibration speed selected by using a rotation button of the selector switch mounted within a switch mounting socket provided at a second truncated end of the hollow casing to change the speed of the motor

6. The massage roller of claim 5, wherein the motor is configured to rotate at a predefined speed from the plurality of speeds when the power source energizes the motor at the predefined speed by providing power corresponding to the predefined speed, and wherein the power source energizes the motor by the corresponding power based on the vibration speed selected using the selector switch and a resistive element corresponding to the vibration speed connected between the power source and the motor by the selector switch.

7. The massage roller of claim 5, wherein the rotation button is operated between at least four positions, and wherein at a first position the power source energizes the motor at a first vibrating speed, at a second position the power source energizes the motor at a second vibrating speed, at a third position the power source energizes the motor at a third vibrating speed, and at a fourth position the power source de-energizes the motor.

8. The massage roller of claim 1, wherein the compressible material comprises of at least one of an elastomer, a foam and a rubber material.

9. The massage roller of claim 1, wherein the hollow casing is a cylindrically shaped casing having a circular cross section, a predefined length, and pair of truncated ends.

10. The massage roller of claim 1, further comprising:
a motor frame with a circular cross-section circumscribing the motor and having an exterior surface comprising a plurality of detents extending radially and spaced at a uniform distance along a circumference of the exterior surface, wherein each detent is attached to an inner surface of the hollow casing to retain a positional alignment of the motor and the each detent dissipates heat generated from the motor.

11. The massage roller of claim 1, wherein the at least one pattern of ridges comprises a plurality of ridges and a plurality of grooves extending axially and along a longitudinal axis of the massage roller on the outer layer and formed of the compressible material, a ridge having a cross-sectional height at least twice as large as a cross-sectional height of a groove and the ridge having a cross-sectional width at least twice as large as a cross-sectional width of the groove.

12. The massage roller of claim 1, wherein the at least one pattern of ridges comprises a plurality of ridges and a plurality of grooves extending axially and along a circumference of the massage roller on the outer layer and formed of the compressible material, a ridge having a cross-sectional height at least twice as large as a cross-sectional height of a groove and having a cross-sectional width at least twice as large as a cross-sectional width of a groove, the at least one pattern of ridges interspersed with at least one patch of polygonal shaped lobes, each lobe spaced at a uniform distance from another lobe in the at least one patch and the each lobe having a cross sectional height at least less than two thirds and greater than half the cross-sectional height of the ridge.

13. The massage roller of claim 1, wherein the at least one pattern of ridges comprises a plurality of ridges and a plurality of first grooves extending axially and along a longitudinal axis of the massage roller on the outer layer and formed of the compressible material, a ridge further comprising of a continuous pattern of alternating plurality of lobes and a plurality of second grooves extending axially on the outer layer and along a part of the longitudinal axis, a lobe having a cross-sectional height at least twice as large as a cross-sectional height of a second groove and the lobe having cross sectional width equal to a cross-sectional height of the second groove, the ridge having a cross-sectional width at least twice as large as a cross-sectional width of a first groove, the at least one pattern of ridges interspersed by a patch comprising the outer layer extending along a circumference of the hollow casing and positioned at a center of the longitudinal axis and having a cross-sectional width equal to the cross-sectional width of the lobe.

14. The massage roller of claim 13, wherein the at least one pattern of ridges may further comprise:
a plurality of fused lobes having a length equal to a summation of lengths of two or more lobes, and a width equal to a summation of widths of the two or more lobes, wherein one or more fused lobes comprises a plurality of polygonal shaped smaller lobes spaced uniformly on a front surface of the one or more fused lobes, and wherein a fused lobe having a cross-sectional height equal to the cross-sectional height of the each lobe.
